(19) United States
(12) Patent Application Publication
(10) Pub. No.: US 2026/0050914 A1
(43) Pub. Date: Feb. 19, 2026

(54) Methods, Systems, and Electronic Devices for Contextually Tracking Supplemental Cash Spends Associated with Digital Transactions

(71) Applicant: Motorola Mobility LLC, Chicago, IL (US)

(72) Inventors: Krishnan Raghavan, Bangalore (IN); Nakul Patel, Bangalore (IN); Prasad A G, Nagpur (IN)

(21) Appl. No.: 18/809,026

(22) Filed: Aug. 19, 2024

(51) Int. Cl. G06Q 20/38; G06Q 20/36

(52) U.S. Cl. CPC G06Q 20/38; G06Q 20/36

(57) ABSTRACT

A method in an electronic device detects, with one or more processors of the electronic device, a financial transaction using a digital wallet application operable on the one or more processors of the electronic device. The method extracts, by the one or more processors, one or more contextual cues from the financial transaction. One or more processors then determine whether one or more supplemental cash payment triggers are identified by the one or more contextual cues extracted from the financial transaction. In response to determining that one or more supplemental cash payment triggers are identified by the one or more contextual cues, the one or more processors present, on a user interface of the electronic device, a prompt facilitating alteration of the financial transaction to include a supplemental cash payment.

### BACKGROUND

### Technical Field

This disclosure relates generally to electronic devices, and more particularly to electronic devices having user interfaces.

### Background Art

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card. It would be advantageous to have improved electronic devices and corresponding methods and systems that simplify this process.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory method in accordance with one or more embodiments of the disclosure.

FIG. 2 illustrates one explanatory electronic device in accordance with one or more embodiments of the disclosure.

FIG. 3 illustrates one explanatory method in accordance with one or more embodiments of the disclosure.

FIG. 4 illustrates one explanatory electronic device in accordance with one or more embodiments of the disclosure.

FIG. 5 illustrates one explanatory electronic device in accordance with one or more embodiments of the disclosure.

FIG. 6 illustrates one explanatory electronic device in accordance with one or more embodiments of the disclosure.

FIG. 7 illustrates one or more method steps in accordance with one or more embodiments of the disclosure.

FIG. 8 illustrates one or more method steps in accordance with one or more embodiments of the disclosure.

FIG. 9 illustrates one or more embodiments of the disclosure.

FIG. 10 illustrates a prior art method.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to determining, by one or more processors, whether one or more supplemental cash payment triggers are identified by one or more contextual cues extracted from a financial transaction using a digital wallet application operable on one or more processors of an electronic device and, in response to determining that one or more supplemental cash payment triggers are identified by the one or more contextual cues, presenting, by the one or more processors on a user interface of the electronic device, a prompt facilitating alteration of the financial transaction to include a supplemental cash payment. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, when one or more processors of an electronic device determine a probable supplemental cash payment transaction occurring concurrently with a financial transaction executed by a digital wallet application operating on the one or more processors, presenting a prompt allowing user input received by the user interface to manipulate the financial transaction executed by the digital wallet application as described herein. The non-processor circuits may include, but are not limited to, a radio receiver, a radio transmitter, signal drivers, clock circuits, power source circuits, and user input devices.

As such, these functions may be interpreted as steps of a method to perform present, by one or more processors on a user interface of an electronic device, a prompt facilitating alteration of an electronic financial transaction to include an amount of a supplemental cash transaction and, in response to user input received by the user input defining the amount of the supplemental cash transaction, replacing, by the one or more processors, an electronic financial transaction amount in a register of the digital wallet application with a modified electronic financial transaction amount comprising the amount of the supplemental cash transaction.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure contemplate that it is frequently the case that a user will make a cash payment when concurrently executing an electronic financial transaction using a digital wallet application operating on one or more processors of an electronic device such as a smartphone. Illustrating by example, when a diner goes to a restaurant to eat a meal, they may pay the restaurant via an electronic financial transaction executed by a digital wallet application operating on one or more processors of a smartphone transacted with a point of sale device operated by the restaurant. Concurrently, they may tip their waitress or waiter using cash.

Illustrating by example, Motorola Mobility has launched a banking application called DIMO.sup.™ in Brazil. Digital banking applications such as DIMO.sup.™ are redefining banking. Indeed, DIMO.sup.™ already has more than one hundred thousand users of the system in Brazil as expects for that number to only continue to grow.

This, as well as other, banking applications are redefining the way that banking occurs. Rather than having to go to a bank to physically talk to a teller during business hours to complete a financial transaction, banking applications offer “24-7” banking with instantaneous transfers of money. Banking can be done exclusively using a smartphone. Even automated teller machine (ATM) withdrawals can be made using only a smartphone.

The advent of applications such as DIMO.sup.™ are leading to users simply ceasing to carry paper currency or coins. Moreover, applications like DIMO.sup.™ have caused people to stop carrying physical credit and debit cards as well since the credit and debit card account information can simply be loaded into a smartphone, with near field and other communication devices allowing direct transactions of money electronically.

Embodiments of the disclosure also contemplate that the banking sector is undergoing rapid disruption globally due to the rise of digital-first players and non-banking entities expanding their fintech presence. Examples include Nubank.sup.™ in Brazil, Revolut.sup.™ and Sterling.sup.™ in the United Kingdom, Jupiter.sup.™ in India, and N26.sup.™ in Europe. These new entrants position themselves as “money managers,” aiming to help users achieve financial freedom by offering services that enhance their understanding of personal finances. An element driving this shift is the implementation of “Spend Insights,” which helps users understand their spending habits by collecting information such as transaction categories, notes, and tags, either manually or automatically, and presenting this information across various dimensions.

DIMO.sup.™ is adopting a similar approach by automatically categorizing user transactions. Additionally, users can modify or add categorizations for transactions and attach images or receipts, add personalized transaction notes, express preferences towards transactions, and incorporate customizable tags to represent sub-categories or specific spending purposes.

Despite the increasing use of digital payments, there are still occasions where users supplement digital transactions with cash components. A primary example of this occurs in the practice of tipping, where additional cash is given to waitstaff in a restaurant or to food delivery agents.

Embodiments of the disclosure contemplate this “additional cash” practice introduces a problem, namely, the fact that supplemental cash amounts often do not appear on banking statements. This problem can lead to discrepancies in spend analysis and budget tracking.

Since cash is not electronically recorded like digital payments, cash transactions create an incomplete financial picture, potentially causing skewed insights and financial planning challenges. Users may forget to add these expenses into their expense tracking tools, leading to inaccuracies and incomplete data representation. Over time, these amounts can become significant, necessitating a method to contextually alert users to add their cash expenses accompanying digital transactions for accurate spend analysis.

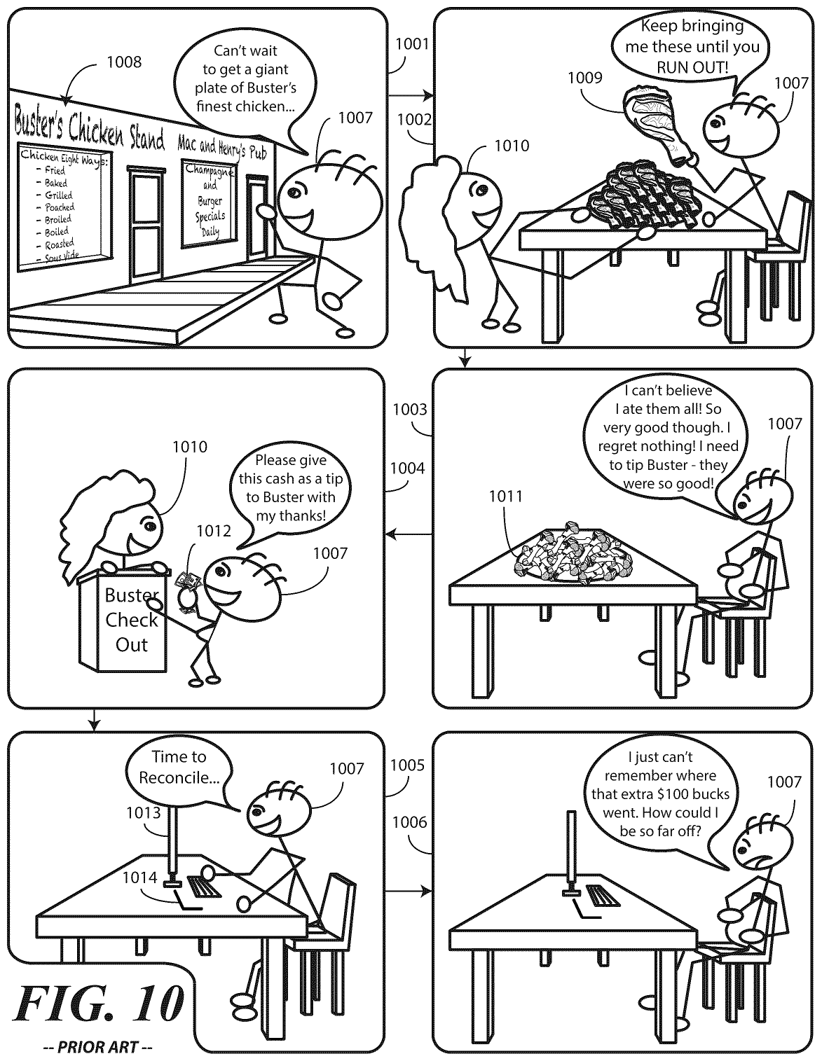

To see how this can occur, turn now to FIG. 10 where a prior art method is shown. Beginning at step 1001, Nakul 1007 is finishing his usual Sunday morning run when he comes across the world famous Buster's Chicken Stand 1008. Buster's Chicken Stand 1008 is universally renowned for some of its exceptionally good chicken 1009, which is served eight different ways. Buster's Chicken Stand 1008 just happens to be located next to the equally famous Mac and Henry's Pub, where Champagne and burgers are served daily as a local favorite specialty.

At step 1002, Nakul 1007 gets to actually try the chicken 1009 for the first time in his life. Having a true epiphany, he cannot believe that he has been missing out on this local delicacy for so long. Determined to make up for lost time, Nakul 1007 tells the kind waitstaff 1010 to keep bringing the chicken 1009 “until you run OUT!”

At step 1003, having finished his tenth platter of chicken, leaving nothing but bones in the “cemeteria” 1011 on the table (a Spanish colloquialism for “the place for the bones”), Nakul 1007 is stuffed. While this will be a large tab, Nakul 1007 regrets nothing as this has been a truly life-changing experience.

Since paying this tab would require a lot of cash (Nakul 1007 ate a lot of chicken 1009, after all), Nakul 1007 is really glad to have his smartphone with its digital wallet application operating on the one or more processors of the smartphone. Using the digital wallet application, transferring a lot of money only takes a few clicks. Plus, the chances of Nakul 1007 getting mugged in his post-chicken stupor since he need not carry large piles of cash in his pocket during his run.

At the same time, Nakul 1007 knows just how much work it was for his friendly waitstaff 1010 to carry all those many platters of chicken 1009, and to remove all those cemeteria 1011 from the table. This was in addition to all the tasty side dishes and beverages Nakul 1007 consumed.

Accordingly, as a show of gratitude, Nakul 1007 offers his friendly waitstaff 1010 a tip in cash 1012 at step 1004. The friendly waitstaff 1010 is thrilled that Nakul 1007 was so happy that he thought to give her a tip. Moreover, she is quite glad that it is in cash, as she left her own smartphone at home and is unable to make electronic financial transactions with Nakul 1007 just now.

There is a problem, however. As shown at step 1005, Nakul 1007 is using his computer 1013 and smartphone 1014, along with a “spend insight” feature of the money manager application running on the computer 1013 to reconcile his monthly expenditures. He can see that he withdrew five hundred dollars from an automated teller machine at the start of the month. However, he has no idea where the cash went.

Nakul 1007 checks with his spouse to see if she remembers anything. She promptly reminds him that he tipped the waiter graciously earlier that week on their anniversary dinner with three hundred dollars. However, not knowing of his run and corresponding discovery of Buster's Chicken Stand 1008, she has no idea either of the calories he consumed there or the cash 1012 he left the friendly waitstaff 1010. Accordingly, while a little relieved at remembering where the three hundred dollars went, at step 1006 he is still miffed because the mystery of the missing case of two hundred dollars still persists.

Advantageously, embodiments of the disclosure provide a solution to this problem. In one or more embodiments, methods, systems, and electronic devices contextually alert users about potential cash spends associated with digital transactions, thereby capturing these supplemental cash amounts for accurate spend analysis. Unlike existing solutions, embodiments of the disclosure leverage contextual cues such as location, calendar events, and notifications to identify situations where cash might be used alongside digital payments, such as tipping in restaurants or paying delivery agents. By prompting users to record these cash transactions, embodiments of the disclosure ensure a more comprehensive and accurate financial picture, addressing the common issue of untracked cash expenses that can disrupt budget tracking and spend analysis. This innovative approach not only enhances personal financial management but also provides valuable insights into user spending habits, which can be crucial for credit scoring and financial planning.

In one or more embodiments, a method in an electronic device comprises detecting, with one or more processors of the electronic device, a financial transaction using a digital wallet application operable on the one or more processors of the electronic device. In one or more embodiments, the method comprises extracting, by the one or more processors, one or more contextual cues from the financial transaction.

In one or more embodiments, the method comprises determining, by the one or more processors, whether one or more supplemental cash payment triggers are identified by the one or more contextual cues extracted from the financial transaction. In one or more embodiments, in response to determining that one or more supplemental cash payment triggers are identified by the one or more contextual cues, the method comprises presenting, by the one or more processors on a user interface of the electronic device, a prompt facilitating alteration of the financial transaction to include a supplemental cash payment.

Thus, the disclosed method advantageously addresses the issue of untracked supplemental cash spends associated with digital transactions. By leveraging contextual cues such as location, calendar events, and notifications, the method identifies situations where cash might be used alongside digital payments, such as tipping in restaurants or paying delivery agents. The method then prompts users to record these cash transactions, ensuring a more comprehensive and accurate financial picture. This approach not only enhances personal financial management but also provides insights into user spending habits, which can be significant for credit scoring and financial planning.

In one or more embodiments, an electronic device comprises a user interface, a communication device, and one or more processors operable with the user interface and communication device. In one or more embodiments, the one or more processors operate a digital wallet application.

In one or more embodiments, the one or more processors are configured to determine a probable supplemental cash payment transaction occurring concurrently with a financial transaction executed by the digital wallet application. In one or more embodiments, in response, to present a prompt allowing user input received by the user interface to manipulate the financial transaction executed by the digital wallet application.

Advantageously, embodiments of the disclosure detect digital payments that may have associated supplemental cash spends, such as tips in restaurants or payments to delivery agents. In one or more embodiments, one or more processors of an electronic device operating a digital wallet application detect these digital payments using various touchpoints, including location data, calendar notices, and notifications. For instance, the system can detect events like bill payments at restaurants, deliveries of online orders, hotel check-ins, and ride completions. The system also learns from past contexts where digital transactions have been supplemented with cash.

Once a potential supplemental cash spend is identified, in one or more embodiments the system prompts the user to record the cash amount. Depending on the type of digital transaction, the prompt can be immediate, event-based, or delayed. Immediate prompts occur right after the digital payment, while event-based prompts are triggered by associated events such as food deliveries or hotel checkouts. In one or more embodiments, delayed prompts appear when the user reviews their transactions in the application. This ensures that users are reminded to add their cash expenses, providing a more accurate financial picture.

The system also categorizes the supplemental cash spends for reporting and budgeting purposes. The system keeps a buffer of these spends for future planning and automatically reconciles them against cash withdrawals from automated teller machines. This comprehensive approach ensures that all cash transactions are accounted for, enhancing the accuracy of spend analysis and budget tracking.

Accordingly, in one or more embodiments a method in an electronic device comprises identifying, by one or more processors of the electronic device, one or more contextual signals indicative of an electronic financial transaction occurring in a digital wallet application operating on the one or more processors occurring concurrently with a supplemental cash transaction associated with the electronic financial transaction. In one or more embodiments, the method presents, by the one or more processors on a user interface of the electronic device, a prompt facilitating alteration of the electronic financial transaction to include an amount of the supplemental cash transaction.

In one or more embodiments, the prompt comprises a user actuation target allowing a user to adjust the cash payment amount. In one or more embodiments, the method receives, by the user interface of the electronic device, user input defining the amount of the supplemental cash transaction. In one or more embodiments, in response to the user input defining the cash amount, the method comprises replacing, by the one or more processors, an electronic financial transaction amount in a register of the digital wallet application with a modified electronic financial transaction amount comprising the amount of the supplemental cash transaction.

Embodiments of the disclosure offer numerous advantages over prior art systems. Illustrating by example, by detecting a financial transaction using a digital wallet application and extracting contextual cues from the transaction, the system can identify potential supplemental cash payment triggers. This allows the system to present a prompt on the user interface, facilitating the inclusion of supplemental cash payments. This method ensures that cash transactions, which are often overlooked, are recorded alongside digital transactions, providing a more accurate and comprehensive financial picture for the user.

The arrangement of detecting contextual cues and presenting prompts immediately or based on events ensures that users are reminded to record their cash expenses in a timely manner. This reduces the likelihood of forgotten cash transactions, thereby improving the accuracy of spend analysis and budget tracking. For example, if a user makes a digital payment at a restaurant, the system can prompt the user to add any cash tips given, ensuring that the tip is accounted for in their financial records.

This method leverages various touchpoints such as location data, calendar events, and notifications to detect potential cash spends. This contextual awareness is a novel approach compared to existing solutions that rely solely on user input or manual entry. By automating the detection and prompting process, the system reduces the cognitive load on the user and enhances the overall user experience in managing personal finances.

Furthermore, the ability to reconcile cash spends against cash withdrawals and categorize them for future planning and budgeting provides users with valuable insights into their spending habits. This can be particularly useful for financial planning and credit scoring, as it offers a more detailed and accurate representation of the user's financial behavior.

By configuring one or more processors to determine a probable supplemental cash payment transaction occurring concurrently with a financial transaction executed by the digital wallet application, the electronic device can automatically identify situations where cash might be used alongside digital payments. This arrangement ensures that supplemental cash transactions, such as tips or additional payments, are not overlooked, providing a more accurate and comprehensive financial picture for the user.

The integration of the user interface and communication device with the processors allows for real-time prompts to be presented to the user. This prompt facilitates the inclusion of supplemental cash payments in the financial transaction, thereby reducing the likelihood of forgotten cash transactions and improving the accuracy of spend analysis and budget tracking.

Compared to existing solutions that rely solely on manual entry, this method leverages contextual cues and automated detection to reduce the cognitive load on the user. For example, if a user makes a digital payment at a restaurant, the system can prompt the user to add any cash tips given, ensuring that the tip is accounted for in their financial records. This enhances the overall user experience in managing personal finances by providing timely reminders and reducing the chances of untracked expenses.

By identifying contextual signals indicative of an electronic financial transaction occurring concurrently with a supplemental cash transaction, embodiments of the disclosure ensure that cash transactions, which are often overlooked, are recorded alongside digital transactions. This provides a more accurate and comprehensive financial picture for the user, addressing the common issue of untracked cash expenses that can disrupt budget tracking and spend analysis.

Presenting a prompt on the user interface to facilitate the alteration of the electronic financial transaction to include the amount of the supplemental cash transaction ensures that users are reminded to record their cash expenses in a timely manner. This reduces the likelihood of forgotten cash transactions, thereby improving the accuracy of spend analysis and budget tracking.

Receiving user input defining the amount of the supplemental cash transaction and replacing the electronic financial transaction amount in the digital wallet application with a modified amount that includes the supplemental cash transaction ensures that the financial records are updated accurately. This automated process reduces the cognitive load on the user and enhances the overall user experience in managing personal finances.

By leveraging contextual signals such as electronic communications from merchant payment processor systems, the method can accurately detect and prompt for supplemental cash transactions even if the user does not manually input this information. This enhances the reliability and completeness of financial data captured by the digital wallet application.

Delaying the presentation of the prompt until a predefined event occurs subsequent to the electronic financial transaction allows for flexibility in capturing supplemental cash transactions. This ensures that the prompt is contextually relevant and timely, further improving the accuracy of financial records and user compliance in recording cash expenses. Other advantages will be described below. Still others will be obvious to those of ordinary skill in the art having the benefit of this disclosure.

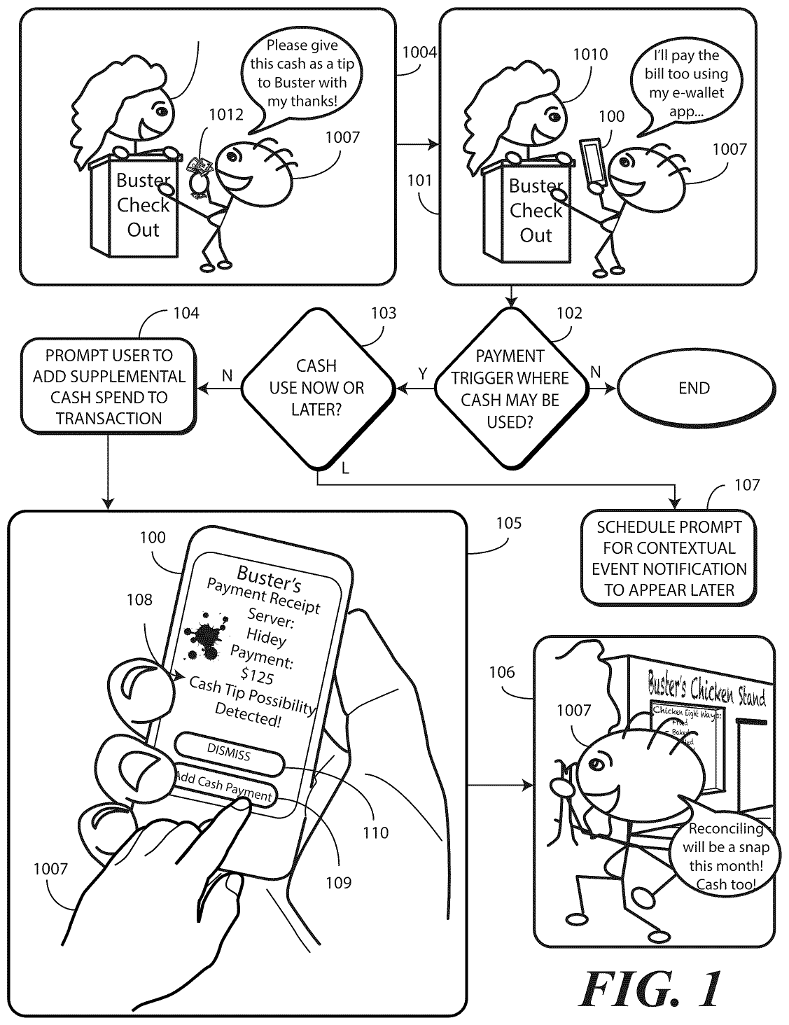

To see some of the advantages in action, turn now to FIG. 1. The method depicted in FIG. 1 begins at step 1004 from FIG. 10, where our friendly high roller, Nakul 1007, as a show of gratitude, offers his friendly waitstaff 1010 a tip in cash 1012. The friendly waitstaff 1010 is again thrilled that Nakul 1007 was so happy that he thought to give her a tip.

Fortunately for Nakul 1007, in FIG. 1 he is using an electronic device 100 configured in accordance with embodiments of the disclosure. Accordingly, at step 101 Nakul 1007 uses the electronic device 100, with the digital wallet application operating on its one or more processors, to initiate a financial transaction using the digital wallet application to pay for his large chicken tab. The friendly waitstaff 1010, operating the point of sale system belonging to the restaurant, is happy to close Nakul's tab via the financial transaction.

Decision 102 detects, with the one or more processors of the electronic device 100, the financial transaction using the digital wallet application operable on the one or more processors. Decision 103 extracts, by the one or more processors, one or more contextual cues from the financial transaction to determine, for example, whether there is a probable concurrent cash spend, whether there is a later probable cash spend, and so forth. In one or more embodiments, decision 103 therefore determines whether one or more supplemental cash payment triggers are identified from the one or more contextual cues extracted from the financial transaction, with just two examples being whether the cash spend occurs now or later.

At step 104, in response to decision 103 determining that one or more supplemental cash payment triggers indicating a concurrent additional cash spend is likely to occur, the one or more processors of the electronic device 100 present on a user interface of the electronic device 100, a prompt facilitating alteration of the financial transaction to include a supplemental cash payment. Such a prompt 108 is presented at step 105.

Step 105 of FIG. 1 involves presenting a prompt 108 on the user interface of the electronic device 100. In one or more embodiments, this step 105 occurs after the one or more processors of the electronic device 100 have determined that one or more supplemental cash payment triggers are identified by the contextual cues extracted from the financial transaction.

In one or more embodiments, the prompt 108 facilitates the alteration of the financial transaction to include a supplemental cash payment. In the illustrative embodiment of FIG. 1, the prompt 108 comprises two user actuation targets. A first user actuation target 109 facilitates alteration of the financial transaction to include the supplemental cash payment. Another user actuation target 110 allows dismissal of the prompt 108.

Actuation of user actuation target 109, presented by the user interface of the electronic device 100 with the prompt 108, allows Nakul 1007 to input the amount of the supplemental cash transaction. This interaction ensures that the cash transaction is recorded alongside the digital transaction, providing a more accurate financial picture.

The prompt 108 presented at step 105 can take various forms depending on the implementation. For instance, the prompt 108 may include a user actuation target 109, such as a button or a text field, that allows the user to enter the cash amount. The user interface may also display details of the financial transaction, such as the merchant's name, transaction amount, and date, to provide context for the user. This contextual information helps the user recall the cash transaction associated with the digital payment.

In some embodiments, the prompt 108 may be designed to appear immediately after the digital transaction is detected, ensuring that the user is reminded to record the cash transaction while the event is still fresh in their memory. In other embodiments, such as at step 107, the prompt 108 may be event-based, appearing when a related event occurs, such as the completion of a food delivery or hotel checkout. This flexibility in prompt timing ensures that the system can adapt to different types of transactions and user behaviors.

The user interface of the electronic device 100 plays a role in facilitating user interaction with the prompt 108. The design of the user interface be intuitive and user-friendly, allowing users to quickly and easily input the cash amount. The interface may also provide options for categorizing the cash transaction, adding notes, or attaching receipts, further enhancing the accuracy and detail of the financial records.

Once the user inputs the cash amount, in one or more embodiments the one or more processors of the electronic device 100 update the financial transaction in the digital wallet application to include the supplemental cash payment. This update ensures that the cash transaction is recorded in the transaction database, providing a comprehensive view of the user's spending. The system may also reconcile the cash transaction with cash withdrawals from automated teller machines, ensuring that all cash transactions are accounted for in the user's financial records.

In summary, step 105 of FIG. 1 involves presenting a prompt 108 on the user interface of the electronic device 100 to facilitate the recording of supplemental cash transactions associated with digital payments. This step 105 ensures that cash transactions are accurately recorded alongside digital transactions, providing a more comprehensive and accurate financial picture for the user. As shown at step 106, Nakul 1007 is tickled that the electronic device 100, configured in accordance with embodiments of the present disclosure, will make reconciling his account simple and easy this month. The prior art problem of forgetting two hundred dollars is a thing of the past thanks to the many benefits offered by embodiments of the disclosure.

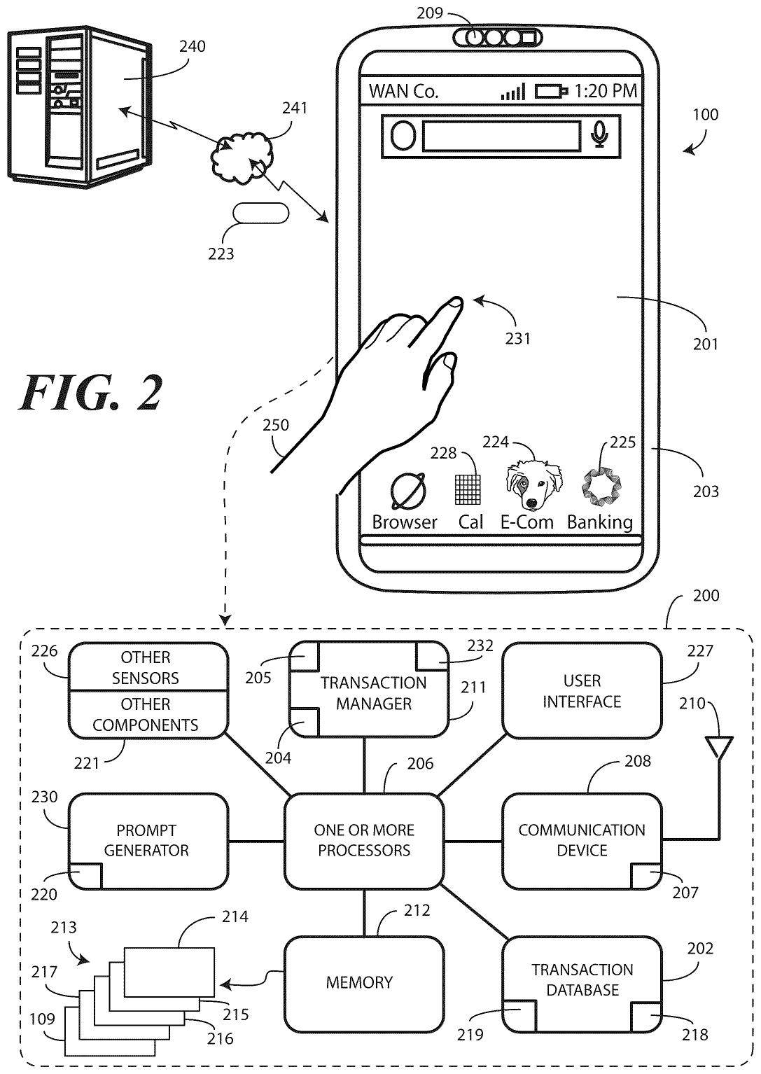

Turning now to FIG. 2, illustrated therein is one explanatory electronic device 100 configured in accordance with one or more embodiments of the disclosure. The electronic device 100 of this illustrative embodiment includes a user interface 227. In one or more embodiments, the user interface 227 comprises a display 201, which may optionally be touch-sensitive. The display 201 can serve as a primary user interface 227 of the electronic device 100.

Where the display 201 is touch sensitive, users can deliver user input to the display 201 by delivering touch input from a finger, stylus, or other objects disposed proximately with the display. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 100 of FIG. 2 includes a housing 203. Features can be incorporated into the housing 203. Examples of features that can be included along the housing 203 include an imager 209, shown as a camera in FIG. 2, or an optional speaker port. A user interface component, which may be a button or touch sensitive surface, can also be disposed along the housing 203.

A block diagram schematic 200 of the electronic device 100 is also shown in FIG. 2. In one embodiment, the electronic device 100 includes one or more processors 206. In one embodiment, the one or more processors 206 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device.

The application processor and the auxiliary processor(s) can be operable with the various components of the electronic device 100. Each of the application processor and the auxiliary processor(s) can be configured to process and execute executable software code to perform the various functions of the electronic device 100. A storage device, such as memory 212, can optionally store the executable software code used by the one or more processors 206 during operation.

In this illustrative embodiment, the electronic device 100 also includes a communication device 208 that can be configured for wired or wireless communication with one or more other devices or networks. The networks can include a wide area network, a local area network, and/or personal area network. The communication device 208 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 208 can include wireless communication circuitry, one of a receiver, a transmitter, or transceiver, and one or more antennas 210.

The electronic device 100 can optionally include a near field communication circuit 207 used to exchange data, power, and electrical signals between the electronic device 100 and another electronic device. In one embodiment, the near field communication circuit 207 is operable with a wireless near field communication transceiver, which is a form of radio-frequency device configured to send and receive radio-frequency data to and from the companion electronic device or other near field communication objects.

Where included, the near field communication circuit 207 can have its own near field communication circuit controller in one or more embodiments to wirelessly communicate with companion electronic devices using various near field communication technologies and protocols. The near field communication circuit 207 can include—as an antenna—a communication coil that is configured for near-field communication at a particular communication frequency. The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 206 can be responsible for performing the primary functions of the electronic device 100. For example, in one embodiment the one or more processors 206 comprise one or more circuits operable to present presentation information, such as images, text, and video, on the display 201. The executable software code used by the one or more processors 206 can be configured as one or more modules 213 that are operable with the one or more processors 206. Such modules 213 can store instructions, control algorithms, and so forth.

In one embodiment, the one or more processors 206 are responsible for running the operating system environment 214. The operating system environment 214 can include a kernel, one or more drivers, and an application service layer 215, and an application layer 216. The operating system environment 214 can be configured as executable code operating on one or more processors or control circuits of the electronic device 100.

The application service layer 215 can be responsible for executing application service modules. The application service modules may support one or more applications 217 or “apps.” Examples of such applications include a cellular telephone application for making voice telephone calls, a web browsing application configured to allow the user to view webpages on the display 201 of the electronic device 100, an electronic mail application configured to send and receive electronic mail, a photo application configured to organize, manage, and present photographs on the display 201 of the electronic device 100, and a camera application for capturing images with the imager 209. Collectively, these applications constitute an “application suite.” In one or more embodiments, these applications comprise one or more e-commerce applications 224 and/or banking applications 225 that allow electronic commerce orders to be placed and financial transactions to be made using the electronic device 100.

Illustrating by example, in one or more embodiments a user can deliver user input to an e-commerce application 224 or a banking application 225 to enter an electronic payment transaction request 232 or otherwise request an electronic payment transaction occur. In one or more embodiments, when this occurs, the one or more processors 206, using one or more sensors 226, extract one or more contextual cues 204 from the electronic payment transaction or electronic financial transaction.

Contextual cues 204 extracted from an electronic financial transaction can include various data points that provide insight into the nature and circumstances of the transaction. One example of a contextual cue 204 is location data, which can be obtained from the GPS module of the electronic device. These data can indicate whether the transaction occurred at a specific type of establishment, such as a restaurant, coffee shop, or hotel, where supplemental cash spends like tips are common. Another example is calendar events, which can be cross-referenced with the transaction to determine if the payment coincides with a scheduled event, such as a hotel check-out or a food delivery appointment.

Notifications received by the electronic device 100 can also serve as contextual cues 204. For instance, a notification from a food delivery application indicating the completion of a delivery can prompt the system to alert the user to record any cash tip given to the delivery agent. Similarly, notifications from ride-sharing applications can signal the end of a ride, prompting the user to add any cash tip provided to the driver. Additionally, transaction metadata such as the merchant's name, transaction amount, and time of the transaction can be analyzed to identify patterns that suggest the likelihood of a supplemental cash spend.

Historical transaction data stored in the digital wallet application 205 can further enhance the identification of contextual cues 204. By analyzing past transactions 218 in a transaction database 202, the system can learn and predict scenarios where supplemental cash spends are likely. For example, if a user frequently tips at certain restaurants, the system can use this historical data to prompt the user to record a cash tip whenever a transaction is made at those establishments. This predictive capability ensures that supplemental cash transactions are consistently captured, providing a more accurate financial picture.

The one or more processors 206 can determine whether one or more supplemental cash payment triggers are identified by the one or more contextual cues 204 extracted from the financial transaction. Examples of supplemental cash payment triggers identified by the one or more contextual cues 204 include various scenarios where cash transactions typically accompany digital payments. One such example is the detection of a digital payment at a restaurant. The system can identify this context through location data indicating the user's presence at a dining establishment, transaction metadata showing a payment to a restaurant, or calendar events marking a dining reservation. In this scenario, the system can prompt the user to record any cash tip given to the waitstaff, ensuring that the cash transaction is captured alongside the digital payment.

Another example involves the delivery of online orders, such as food or furniture. The system can detect the completion of a delivery through notifications from delivery applications or location data indicating the arrival of a delivery agent. Upon identifying this context, the system can prompt the user to add any cash tip provided to the delivery agent. This ensures that the cash transaction is recorded, providing a more accurate financial picture.

Hotel check-ins and check-outs also serve as contextual cues 204 for potential supplemental cash payments. The system can identify these events through calendar entries marking hotel reservations or notifications from hotel booking applications. When a user checks in or out of a hotel, the system can prompt the user to record any cash tips given to hotel staff, such as bellhops or housekeeping. This contextual awareness ensures that all cash transactions associated with the hotel stay are accurately recorded.

Ride completions, such as those from ride-sharing services, provide another example of supplemental cash payment triggers. The system can detect the end of a ride through notifications from ride-sharing applications or location data indicating the user's arrival at a destination. In this context, the system can prompt the user to add any cash tip given to the driver, ensuring that the cash transaction is captured alongside the digital payment.

Additional examples include payments to service providers such as babysitters, pet care professionals, and salon or spa staff. The system can identify these contexts through calendar events marking appointments or notifications from service booking applications. Upon completion of the service, the system can prompt the user to record any cash tips provided, ensuring that these transactions are accurately captured in the user's financial records

In one or more embodiments, in response to determining that one or more supplemental cash payment triggers are identified by the one or more contextual cues 204, the one or more processors 206 can cause the user interface 227 to present a prompt 220 facilitating alteration of the financial transaction to include a supplemental cash payment. Said differently, in one or more embodiments where the one or more processors 206 determine a probable supplemental cash payment transaction occurring concurrently with a financial transaction executed by the digital wallet application 205, in response the one or more processors 206 can cause the user interface 227 to present a prompt 220 allowing user input 231 received by the user interface 227 to manipulate the financial transaction executed by the digital wallet application 205.

In one or more embodiments, the one or more processors 206 are responsible for managing the applications and all personal information received from the user interface 227 that is to be used by the finance application 224 and/or banking application 225 after the electronic device 100 is authenticated as a secure electronic device and the user identification credentials have triggered an electronic payment transaction request 232. The one or more processors 206 can also be responsible for launching, monitoring, and killing the various applications and the various application service modules. In one or more embodiments, the one or more processors 206 are operable to not only kill the applications, but also to expunge any and all personal data, data, files, settings, or other configuration tools when the electronic device 100 is reported stolen or when the finance application 224 and/or banking application 225 are used with fraudulent activity to wipe the memory 212 clean of any personal data, preferences, or settings of the person previously using the electronic device 100.

In one or more embodiments, the one or more processors 206, in response to the user input 231, alter the financial transaction by an amount defined by the user input 231. In one or more embodiments, the one or more processors 206, in response to the digital wallet application 205 being transitioned to a reconciliation mode of operation, present the amount defined by the user input 231 as a visible adjustment to the financial transaction.

In one or more embodiments, the one or more processors 206, in response to other user input being received by the user interface 227 that interacts with a user selected financial transaction 219 presented in the reconciliation mode of operation. The one or more processors 206 then present another prompt allowing subsequent user input received by the user interface 227 to manipulate the user selected financial transaction 219 presented in the reconciliation mode of operation from the transaction database 202.

The one or more processors 206 can also be operable with other components 221. The other components 221, in one embodiment, include input components, which can include acoustic detectors as one or more microphones. The one or more processors 206 may process information from the other components 221 alone or in combination with other data, such as the information stored in the memory 212 or information received from the user interface.

The other components 221 can include a video input component such as an optical sensor, another audio input component such as a second microphone, and a mechanical input component such as button. The other components 221 can include one or more sensors 226, which may include key selection sensors, touch pad sensors, capacitive sensors, motion sensors, and switches. Similarly, the other components 221 can include video, audio, and/or mechanical outputs.

The one or more sensors 226 may include, but are not limited to, accelerometers, touch sensors, surface/housing capacitive sensors, audio sensors, and video sensors. Touch sensors may be used to indicate whether the electronic device 100 is being touched at side edges. The other components 221 of the electronic device can also include a device interface to provide a direct connection to auxiliary components or accessories for additional or enhanced functionality and a power source, such as a portable battery, for providing power to the other internal components and allow portability of the electronic device 100.

In one or more embodiments, the electronic device 100 comprises transaction database 202 that serves as a register of the digital wallet application 205. In response to user input defining an amount of a supplemental cash transaction, the one or more processors 206 can replace an electronic financial transaction amount in the transaction database 202 with a modified electronic financial transaction amount comprising the amount of the supplemental cash transaction.

In one or more embodiments, the electronic device 100 comprises a prompt generator 230 as well. Embodiments of the disclosure contemplate that it can be advantageous to alert a user 250 when contextual signals, examples of which include the communication device 208 of the electronic device receiving an electronic communication 223 from a merchant payment processor system 240 across a network 241, indicative that an electronic financial transaction is occurring in a digital wallet application 205 operating on the one or more processors 206 occurring concurrently with a supplemental cash spend transaction associated with the electronic financial transaction. Accordingly, in one or more embodiments the prompt generator 230 presents a prompt 220 facilitating alteration of the electronic financial transaction to include an amount of the supplemental cash transaction.

In one or more embodiments, the electronic device 100 also includes a transaction manager 211 operable to detect the financial transaction and its probable additional cash spend occurring. In one or more embodiments, the transaction manager 211 and the prompt generator 230 can be operable with one or more processors 206, configured as a component of the one or more processors 206, or configured as one or more executable code modules operating on the one or more processors 206. In other embodiments, the transaction manager 211 and the prompt generator 230 can be standalone hardware components operating executable code or firmware to perform their functions. Other configurations for the transaction manager 211 and the prompt generator 230 will be obvious to those of ordinary skill in the art having the benefit of this disclosure.

In one or more embodiments, the transaction manager 211 is operable to determine, from contextual cues or signals received by the electronic device 100, whether an electronic payment transaction request 232 is likely to have an additional cash spend. In one or more embodiments, the transaction manager 211 determines whether the one or more supplemental cash payment triggers are identified by the one or more contextual cues or signals extracted from the electronic financial transaction. These supplemental cash payment triggers can vary.

Illustrating by example, in one or more embodiments the one or more supplemental cash payment triggers comprise the financial transaction being made with a food vendor. In other embodiments, the one or more supplemental cash payment triggers comprise the financial transaction being made to complete a delivery.

In still other embodiments, the one or more supplemental cash payment triggers comprise a calendaring event stored in a calendaring application 228 operating on the one or more processors 206 that identifies a merchant. In other embodiments, the one or more supplemental cash payment triggers comprise the electronic device 100 being collocated with a merchant, as determined by a location detector included with the one or more sensors 226. Of course, these supplemental cash payment triggers can be used in combination. Moreover, other supplemental cash payment triggers were described above and can be used with those described here. Still other supplemental cash payment triggers will be obvious to those of ordinary skill in the art having the benefit of this disclosure.

Thus, as described above, FIG. 2 illustrates an explanatory electronic device 100 configured in accordance with one or more embodiments of the disclosure. In one or more embodiments, a user can deliver user input to an e-commerce application 224 or a banking application 225 to enter an electronic payment transaction request 232 or otherwise request an electronic payment transaction occur.

When this occurs, in one or more embodiments the one or more processors 206, using one or more sensors 226, extract one or more contextual cues from the electronic payment transaction or electronic financial transaction. Contextual cues extracted from an electronic financial transaction can include various data points that provide insight into the nature and circumstances of the transaction.

One example of a contextual cue is location data, which can be obtained from the GPS module of the electronic device. These data can indicate whether the transaction occurred at a specific type of establishment, such as a restaurant, coffee shop, or hotel, where supplemental cash spends like tips are common. Another example is calendar events, which can be cross-referenced with the transaction to determine if the payment coincides with a scheduled event, such as a hotel check-out or a food delivery appointment.

Notifications received by the electronic device 100 can also serve as contextual cues. For instance, a notification from a food delivery application indicating the completion of a delivery can prompt the system to alert the user to record any cash tip given to the delivery agent. Similarly, notifications from ride-sharing applications can signal the end of a ride, prompting the user to add any cash tip provided to the driver. Additionally, transaction metadata such as the merchant's name, transaction amount, and time of the transaction can be analyzed to identify patterns that suggest the likelihood of a supplemental cash spend.

Historical transaction data stored in the digital wallet application 205 can further enhance the identification of contextual cues. By analyzing past transactions 218 in a transaction database 202, the system can learn and predict scenarios where supplemental cash spends are likely. For example, if a user frequently tips at certain restaurants, the system can use this historical data to prompt the user to record a cash tip whenever a transaction is made at those establishments. This predictive capability ensures that supplemental cash transactions are consistently captured, providing a more accurate financial picture.

The one or more processors 206 can determine whether one or more supplemental cash payment triggers are identified by the one or more contextual cues extracted from the financial transaction. Examples of supplemental cash payment triggers identified by the one or more contextual cues include various scenarios where cash transactions typically accompany digital payments.

One such example is the detection of a digital payment at a restaurant. The system can identify this context through location data indicating the user's presence at a dining establishment, transaction metadata showing a payment to a restaurant, or calendar events marking a dining reservation. In this scenario, the system can prompt the user to record any cash tip given to the waitstaff, ensuring that the cash transaction is captured alongside the digital payment.

Another example involves the delivery of online orders, such as food or furniture. The system can detect the completion of a delivery through notifications from delivery applications or location data indicating the arrival of a delivery agent. Upon identifying this context, the system can prompt the user to add any cash tip provided to the delivery agent. This ensures that the cash transaction is recorded, providing a more accurate financial picture.

Hotel check-ins and check-outs also serve as contextual cues for potential supplemental cash payments. The system can identify these events through calendar entries marking hotel reservations or notifications from hotel booking applications. When a user checks in or out of a hotel, the system can prompt the user to record any cash tips given to hotel staff, such as bellhops or housekeeping. This contextual awareness ensures that all cash transactions associated with the hotel stay are accurately recorded.

Ride completions, such as those from ride-sharing services, provide another example of supplemental cash payment triggers. The system can detect the end of a ride through notifications from ride-sharing applications or location data indicating the user's arrival at a destination. In this context, the system can prompt the user to add any cash tip given to the driver, ensuring that the cash transaction is captured alongside the digital payment.

Additional examples include payments to service providers such as babysitters, pet care professionals, and salon or spa staff. The system can identify these contexts through calendar events marking appointments or notifications from service booking applications. Upon completion of the service, the system can prompt the user to record any cash tips provided, ensuring that these transactions are accurately captured in the user's financial records.

In response to determining that one or more supplemental cash payment triggers are identified by the one or more contextual cues, the one or more processors 206 can cause the user interface 227 to present a prompt 220 facilitating alteration of the financial transaction to include a supplemental cash payment. In one or more embodiments where the one or more processors 206 determine a probable supplemental cash payment transaction occurring concurrently with a financial transaction executed by the digital wallet application 205, in response the one or more processors 206 can cause the user interface 227 to present a prompt 220 allowing user input 231 received by the user interface 227 to manipulate the financial transaction executed by the digital wallet application 205.

The one or more processors 206, in response to the user input 231, can alter the financial transaction by an amount defined by the user input 231 in one or more embodiments. Illustrating by example, the one or more processors 206, in response to the digital wallet application 205 being transitioned to a reconciliation mode of operation, present the amount defined by the user input 231 as a visible adjustment to the financial transaction. The one or more processors 206, in response to other user input being received by the user interface 227 that interacts with a user selected financial transaction 219 presented in the reconciliation mode of operation, can then present another prompt allowing subsequent user input received by the user interface 227 to manipulate the user selected financial transaction 219 presented in the reconciliation mode of operation from the transaction database 202.

In one or more embodiments, the electronic device 100 comprises transaction database 202 that serves as a register of the digital wallet application 205. In response to user input defining an amount of a supplemental cash transaction, the one or more processors 206 can replace an electronic financial transaction amount in the transaction database 202 with a modified electronic financial transaction amount comprising the amount of the supplemental cash transaction.

In one or more embodiments the electronic device 100 comprises a prompt generator 230. The prompt generator 230 can be advantageous to alert a user when contextual signals, examples of which include the communication device 208 of the electronic device receiving an electronic communication 223 from a merchant payment processor system 240 across a network 241, indicative that an electronic financial transaction is occurring in a digital wallet application 205 operating on the one or more processors 206 occurring concurrently with a supplemental cash spend transaction associated with the electronic financial transaction. The prompt generator 230 presents a prompt 220 facilitating alteration of the electronic financial transaction to include an amount of the supplemental cash transaction.

In one or more embodiments, the electronic device 100 includes a transaction manager 211 operable to detect the financial transaction and the probable additional cash spend occurring. The transaction manager 211 is operable to determine, from contextual cues or signals received by the electronic device 100, whether an electronic payment transaction request 232 is likely to have an additional cash spend.

In one or more embodiments, the transaction manager 211 determines whether the one or more supplemental cash payment triggers are identified by the one or more contextual cues or signals extracted from the electronic financial transaction. These supplemental cash payment triggers can vary.

The one or more supplemental cash payment triggers comprise the financial transaction being made with a food vendor. The one or more supplemental cash payment triggers comprise the financial transaction being made to complete a delivery. The one or more supplemental cash payment triggers comprise a calendaring event stored in a calendaring application 228 operating on the one or more processors 206 that identifies a merchant. The one or more supplemental cash payment triggers comprise the electronic device 100 being collocated with a merchant, as determined by a location detector included with the one or more sensors 226. These supplemental cash payment triggers can be used in combination. Other supplemental cash payment triggers were described above and can be used with those described here. Still other supplemental cash payment triggers will be apparent to those of ordinary skill in the art having the benefit of this disclosure.

It is to be understood that FIG. 2 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure.

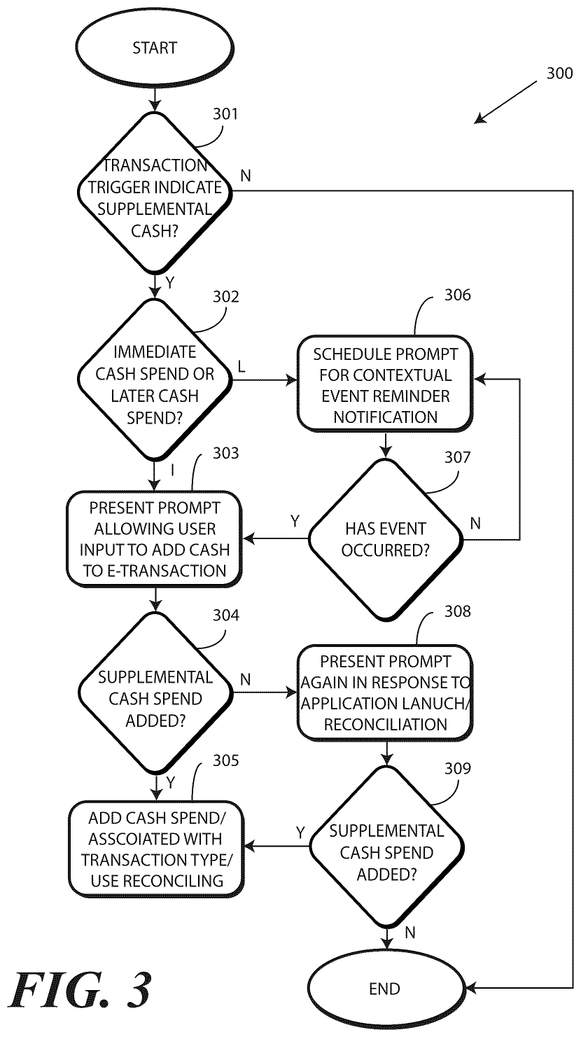

Turning now to FIG. 3, illustrated therein is one explanatory method 300 in accordance with the disclosure. In one or more embodiments, the method 300 comprises detecting, with one or more processors of an electronic device at decision 301, a financial transaction using a digital wallet application operable on the one or more processors of the electronic device. In one or more embodiments, the method 300 comprises extracting, by the one or more processors at decision 301, one or more contextual cues from the financial transaction. In one or more embodiments, the method 300 comprises determining, by the one or more processors at decision 301, whether one or more supplemental cash payment triggers are identified by the one or more contextual cues extracted from the financial transaction. In one or more embodiments, in response to determining that one or more supplemental cash payment triggers are identified by the one or more contextual cues, the method 300 comprises presenting, by the one or more processors on a user interface of the electronic device at step 303 or step 308, a prompt facilitating alteration of the financial transaction to include a supplemental cash payment.

The method 300 begins at decision 301, in which one or more processors of the electronic device determine whether a financial transaction using a digital wallet application operable on the one or more processors of the electronic device has been initiated or is occurring. More specifically, in one or more embodiments decision 301 comprise determining whether one or more supplemental cash payment triggers are identified by one or more contextual cues extracted from the financial transaction. Where the one or more processors of the electronic device detect a financial transaction, extract one or more contextual cues from the financial transaction and determine whether one or more supplemental cash payment triggers are identified by the one or more contextual cues extracted from the financial transaction, the method 300 moves to decision 302. Otherwise, the method 300 ends.

Decision 301 can be made in a variety of ways, many of which have already been described above. In one or more other embodiments, decision 301 comprises querying, from a memory of the electronic device by the one or more processors, past financial transactions from the digital wallet application made by an authorized user of the electronic device that are stored in the memory and determining, by the one or more processors, a repeating pattern of one or more repeating financial transactions comprising supplemental cash payments. Accordingly, decision 301 can determine at least one supplemental cash payment trigger is identified by the one or more contextual cues extracted from the financial transaction when a merchant identified by the one or more repeating financial transactions is identified by the one or more contextual cues.

In one or more embodiments, the one or more supplemental cash payment triggers comprise the financial transaction being made with a food vendor. In one or more embodiments, the one or more supplemental cash payment triggers comprise the financial transaction being made to complete a delivery. In one or more embodiments, the one or more supplemental cash payment triggers comprise a calendaring event stored in a calendaring application operating on the one or more processors that identifies a merchant. In one or more embodiments, the one or more supplemental cash payment triggers comprise the electronic device being collocated with a merchant. Of course, these supplemental cash payment triggers can be used alone or in combination. Moreover, other supplemental cash payment triggers will be obvious to those of ordinary skill in the art having the benefit of this disclosure.

At decision 302, the method 300 determines whether the cash spend associated with the financial transaction will be immediate or at a later time. In one or more embodiments, decision 302 of the method 300 of FIG. 3 determines whether the cash spend associated with a financial transaction will be immediate or at a later time by analyzing contextual cues extracted from the financial transaction. The one or more processors of the electronic device evaluate various data points to ascertain the timing of the supplemental cash spend. For instance, location data can indicate whether the user is currently at a venue where immediate cash spends, such as tipping waitstaff at a restaurant, are likely. Calendar events can provide information on scheduled activities, such as hotel check-outs or service appointments, where cash spends may occur at a later time.

Additionally, notifications received by the electronic device can serve as indicators of the timing of the cash spend. For example, a notification from a food delivery application signaling the completion of a delivery can prompt the system to determine that the cash spend is immediate. Conversely, a calendar entry for a future hotel reservation can indicate that the cash spend will occur at a later time. The system also considers historical transaction data to identify patterns in the user's spending behavior, further refining the determination of whether the cash spend is immediate or delayed.

By leveraging these contextual cues, decision 302 ensures that the prompt for recording the supplemental cash spend is presented at the most relevant time, enhancing the accuracy of financial records and improving the user's experience in managing personal finances. This contextual awareness allows the system to adapt to various transaction scenarios, ensuring that all cash spends are accurately captured and accounted for in the user's financial records.

Where decision 302 determines that the cash spend associated with the financial transaction will be at a later time, step 306 schedules a contextual event reminder to notify the user of the electronic device at the later time at which the cash spend associated with the financial transaction is expected. In one or more embodiments, step 306 results in the presentation of the prompt facilitating alteration of the financial transaction to include the supplemental cash payment being delayed until a subsequent digital wallet application interaction occurs, as determined at decision 307.

Decision 307 then determines whether the event has occurred. This can be done in a variety of ways. As a simple example, in one or more embodiments decision 307 comprises detecting that a subsequent electronic wallet application interaction in the form of a communication device of the electronic device receiving an event completion electronic communication. In other embodiments, the one or more processors can detect a calendar event closing. In still other embodiments, a user can notify the electronic device directly that an event has occurred via delivering user input to a user interface of the electronic device. Other techniques will be obvious to those of ordinary skill in the art having the benefit of this disclosure.

Where it has, or where decision 302 determines that the cash spend associated with the financial transaction will be immediate, the method 300 proceeds to step 303. Otherwise, the method 300 returns to step 306.

At step 303, and in response to determining that one or more supplemental cash payment triggers are identified by the one or more contextual cues, the method 300 comprises presenting, by the one or more processors on a user interface of the electronic device, a prompt. In one or more embodiments, the prompt facilitates alteration of the financial transaction to include a supplemental cash payment.

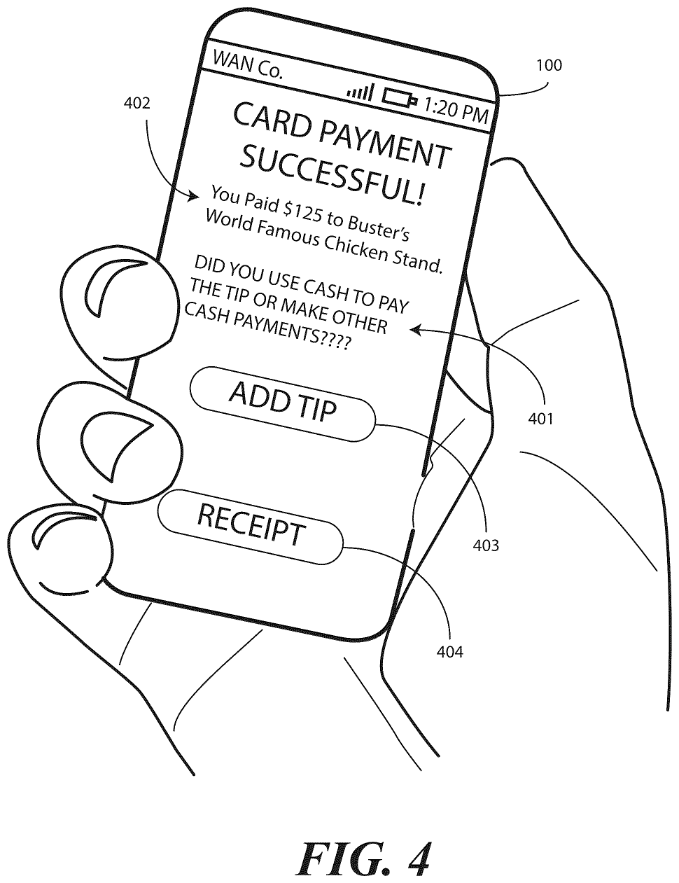

Turning briefly to FIG. 4, illustrated therein is one illustrative example of such a prompt 401, which is presented on the user interface of an electronic device configured in accordance with one or more embodiments of the disclosure. As shown, in this illustrative embodiment the prompt 401 is presented on the user interface of the electronic device 100 concurrently with the details 402 of the financial transaction.

Additionally, in this illustrative embodiment the prompt 401 comprises at least one user actuation target 403,404. User actuation target 403, when actuated via user input, allows the financial transaction to be altered to include a supplemental cash payment.

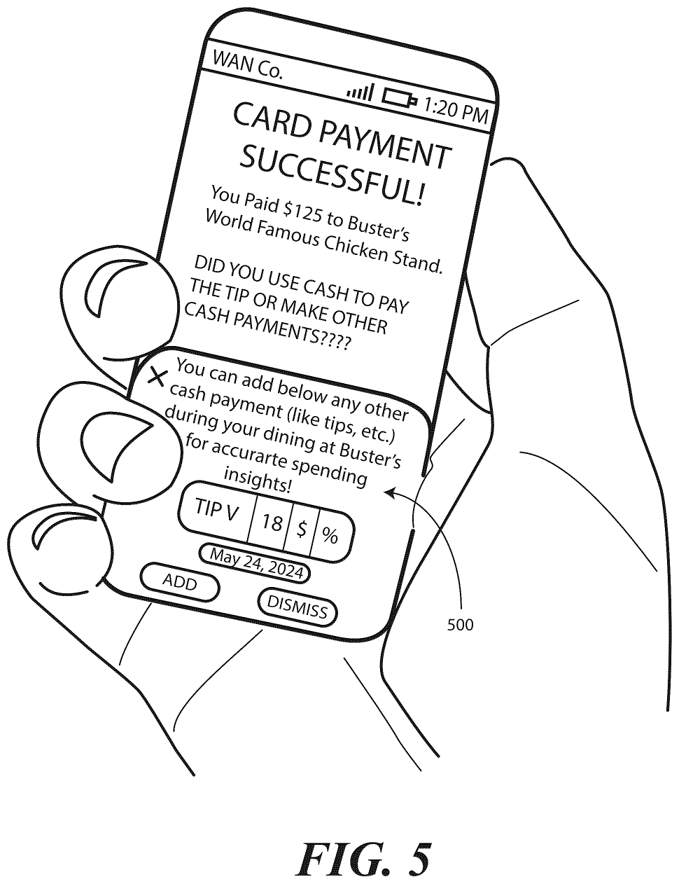

Illustrating by example, turning now to FIG. 5, illustrated herein is a supplemental cash payment user interaction interface 500 that is presented in response to actuation of the user actuation target (403) of FIG. 4. As shown, this supplemental cash payment user interaction interface 500 allows the supplemental cash payment to be added to the financial transaction. In this illustrative example, the supplemental cash payment user interaction interface 500 allows a tip value to be added to the one hundred and twenty-five dollar tab from Buster's Chicken Stand. The supplemental cash payment entry window of the supplemental cash payment user interaction interface 500 advantageously allows for the tip value to be entered as a flat amount (eighteen percent in this example), a custom dollar value, or a custom percentage. The date is presented, and two additional user actuation targets allow the supplemental cash payment user interaction interface 500 to modify the financial transaction or be dismissed. Other examples of prompts (401) and supplemental cash payment user interaction interfaces 500 from those illustrated in FIGS. 4-5 will be obvious to those of ordinary skill in the art having the benefit of this disclosure.

Turning now back to FIG. 3, in one or more embodiments decision 304 determines whether additional user input has been received indicating that the supplemental cash payment has been added to the financial transaction. Where it has, the method 300 moves to step 305. Otherwise, the method 300 moves to step 308.

At step 305, the one or more processors of the electronic device alter the financial transaction to include the supplemental cash payment. In one or more embodiments, step 305 further comprises storing, in a transaction database stored in a memory of the electronic device, the supplemental cash payment in a buffer of supplemental cash payments made since the user interface has received reconciliation user input at the digital wallet application.

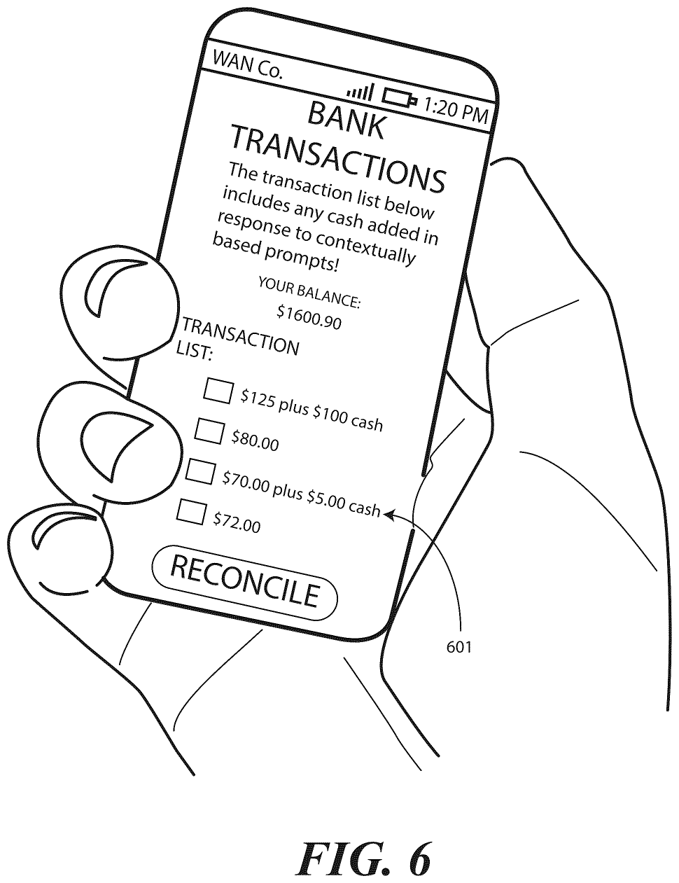

In one or more embodiments, step 308 comprises again presenting the prompt when the digital wallet application is either relaunched or, in response to reconciliation user input being received by the digital wallet application, transitioning the digital wallet application to a reconciliation mode of operation. Turning briefly to FIG. 6, illustrated therein is one example of such a prompt 601 that can be presented when the digital wallet application is either relaunched or is transitioned to a reconciliation mode of operation in response to reconciliation user input being received by the digital wallet application.

As shown, the prompt 601 alerts the user that a cash balance is $1600.90. It also lists a group of transactions made from the account. In this illustration, two of the financial transactions have been altered to include supplemental cash payment, while two others have not. As noted above, in one or more embodiments step (305) comprises storing, in a transaction database stored in a memory of the electronic device, the supplemental cash payment in a buffer of supplemental cash payments. In one or more embodiments, this buffer includes supplemental cash payments made since the user interface has received reconciliation user input at the digital wallet application, examples of which include the two transactions with supplemental cash payments shown in FIG. 6. In one or more embodiments, the one or more processors of the electronic device subtract the buffer of supplemental cash payments to another buffer identifying cash withdrawal transactions to obtain a cash on hand balance. In the illustrative embodiment of FIG. 6, the one or more processors preset the cash on hand balance at the user interface of the electronic device. As shown in this figure, a user actuation target allowing the user to reconcile the account is presented as well, thereby confirming that the digital wallet application is in a reconciliation mode of operation.

Turning now back to FIG. 3, in one or more embodiments decision 309 then determines whether the supplemental cash payment has been added to the financial transaction. Where it has, the method 300 moves to step 305. Otherwise, the method 300 ends.

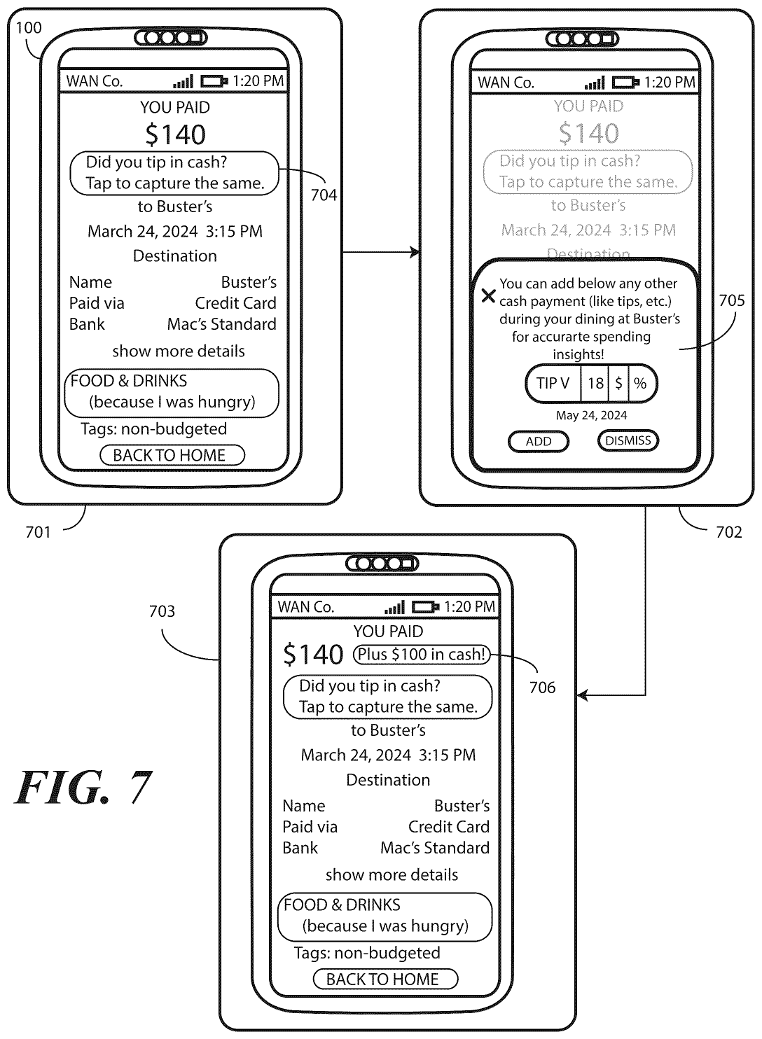

Turning now to FIG. 7, illustrated therein are one or more method steps in accordance with one or more embodiments of the disclosure. Beginning at step 701, one or more processors of an electronic device 100 identify one or more contextual signals indicative of an electronic financial transaction occurring in a digital wallet application operating on the one or more processors occurring concurrently with a supplemental transaction associated with the electronic financial transaction. Illustrating by example, in one or more embodiments the one or more processors can determine this when a communication device receives an electronic communication from a merchant payment processor system.

Where this occurs, as shown at step 701 the one or more processors present, on a user interface of the electronic device 100, a prompt 704 facilitating alteration of the electronic financial transaction to include an amount of the supplemental cash transaction. In one or more embodiments, this is presented concurrently with the presentation of the details of the electronic financial transaction, as shown in FIG. 7. However, as noted above with reference to FIG. 3, in other embodiments presentation of the prompt 704 facilitating alteration of the electronic financial transaction is delayed until a predefined event occurs subsequent to the electronic financial transaction. Examples of such predefined events include a relaunch of the digital wallet application or transitioning the digital wallet application to a reconciliation mode of operation.

Step 702 occurs when a user delivers user input to the user interface of the electronic device actuating the user actuation target defining the prompt 704. When this occurs, the one or more processors of the electronic device present q supplemental cash payment user interaction interface 705 allowing the supplemental cash payment to be added to the electronic financial transaction.

At step 702, a user can deliver user input defining the amount of the supplemental cash transaction. Accordingly, in one or more embodiments step 702 comprises receiving user input defining the amount of the supplemental cash transaction. That this user input has been received is confirmed at step 703 where, in response to the user input, the one or more processors have replaced the electronic financial transaction amount in a register of the digital wallet application with a modified electronic financial transaction amount 706 comprising the amount of the supplemental cash transaction. By comparing step 701 and step 703, it can be seen that the original one hundred and forty dollar charge has been changed to one hundred and forty dollars via the digital wallet application plus another hundred dollars via a supplemental cash payment.

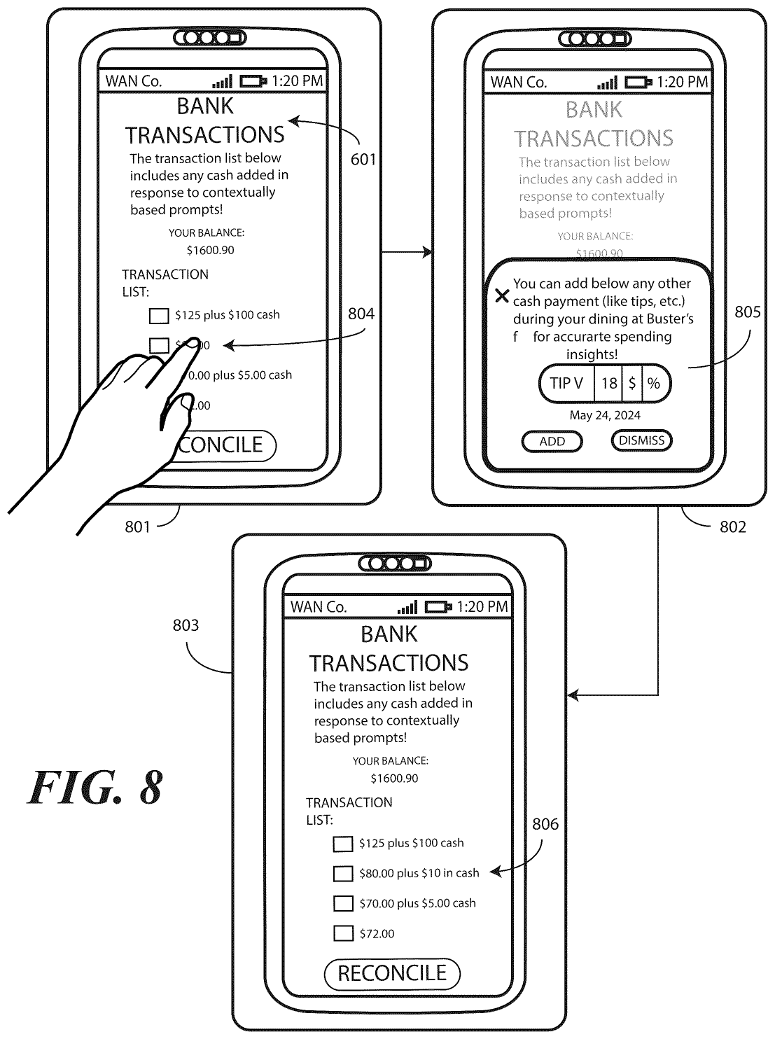

Turning now to FIG. 8, illustrated therein are one or more other method steps in accordance with one or more embodiments of the disclosure. The method steps of FIG. 8 show how supplemental cash payments can be added at a later time in accordance with step (308) of FIG. 3. To wit, in FIG. 8 the user is adding supplemental cash payments during an account reconciliation process.

Beginning at step 801, the prompt 601 of FIG. 6 has been presented in response to user input transitioning the digital wallet application to a reconciliation mode of operation. As such, a list of transactions is presented in the prompt 601. As noted above, two of the transactions have supplemental cash payments added that were added concurrently with the transactions. However, two do not. Still, embodiments of the disclosure allow the user to deliver user input to any one of the transactions, each configured as a supplemental user actuation target, to add a supplemental cash payment during the reconciliation process.

Step 802 occurs when a user delivers user input to the user interface of the electronic device actuating the user actuation target defining the prompt 804. When this occurs, the one or more processors of the electronic device present a supplemental cash payment user interaction interface 805 allowing the supplemental cash payment to be added to the electronic financial transaction.

At step 802, a user can deliver user input defining the amount of the supplemental cash transaction when a supplemental cash payment user interaction interface is presented in response to the user input 804 actuating a transaction occurring at step 801. Accordingly, in one or more embodiments step 802 comprises receiving user input defining the amount of the supplemental cash transaction. That this user input has been received is confirmed at step 803 where, in response to the user input, the one or more processors have replaced the electronic financial transaction amount in the register of the digital wallet application with a modified electronic financial transaction amount (with ten dollars added) comprising the amount of the supplemental cash transaction. By comparing step 801 and step 803, it can be seen that the original eighty charge has been changed to eighty dollars via the digital wallet application plus another ten dollars via a supplemental cash payment.

Thus, as illustrated and described embodiments of the disclosure provide a method in an electronic device for contextually tracking supplemental cash spends associated with digital transactions. In one or more embodiments, the method comprises detecting, with one or more processors of the electronic device, a financial transaction using a digital wallet application operable on the one or more processors of the electronic device. The one or more processors then extract one or more contextual cues from the financial transaction and determine whether one or more supplemental cash payment triggers are identified by the one or more contextual cues extracted from the financial transaction. In one or more embodiments, in response to determining that one or more supplemental cash payment triggers are identified by the one or more contextual cues, the one or more processors present a prompt facilitating alteration of the financial transaction to include a supplemental cash payment. In one or more embodiments, when the user interface receives user input defining the amount of the supplemental cash payment, the one or more processors then update a transaction database to include the supplemental cash payment as part of the financial transaction.

In one or more embodiments, a method in an electronic device where the presentation of the prompt facilitating the alteration of the financial transaction to include the supplemental cash payment is delayed until a subsequent electronic wallet application interaction occurs. This delayed presentation ensures that the prompt is contextually relevant and timely, enhancing the accuracy of financial records and improving the user's experience in managing personal finances. The subsequent electronic wallet application interaction can take various forms, such as the user interface receiving reconciliation user input at the electronic wallet application or a communication device of the electronic device receiving an event completion electronic communication. By delaying the prompt until a relevant interaction occurs, the method ensures that users are reminded to record their cash expenses at an appropriate time, thereby reducing the likelihood of forgotten cash transactions and improving the overall accuracy of spend analysis and budget tracking.

In one or more embodiments, one or more processors of the electronic device, in response to the digital wallet application being transitioned to a reconciliation mode of operation, present the amount as a visible adjustment to the financial transaction. The one or more processors, in response to other user input being received by the user interface that interacts with a user-selected financial transaction presented in the reconciliation mode of operation, present another prompt allowing subsequent user input received by the user interface to manipulate the user-selected financial transaction presented in the reconciliation mode of operation. The one or more processors ensure that the financial transaction amount is updated to reflect the supplemental cash transaction, thereby providing an accurate and comprehensive financial record.

In one or more embodiments, the reconciliation mode of operation allows users to review and adjust their financial transactions, ensuring that all supplemental cash transactions are accounted for. The user interface presents prompts that facilitate the inclusion of supplemental cash payments, reducing the likelihood of forgotten cash transactions. This process enhances the accuracy of spend analysis and budget tracking by ensuring that all cash transactions are recorded alongside digital transactions.

The one or more processors, by presenting prompts during the reconciliation mode of operation, provide users with the flexibility to add supplemental cash transactions at a later time. This delayed prompting ensures that users are reminded to record their cash expenses during a relevant interaction with the digital wallet application, thereby improving the overall user experience in managing personal finances. The system's ability to reconcile cash spends against cash withdrawals further enhances the accuracy of financial records, providing users with a clear and detailed view of their spending habits.

In one or more embodiments, a method in an electronic device comprises identifying, by one or more processors of the electronic device, one or more contextual signals indicative of an electronic financial transaction occurring in a digital wallet application operating on the one or more processors occurring concurrently with a supplemental cash transaction associated with the electronic financial transaction. The method further comprises presenting, by the one or more processors on a user interface of the electronic device, a prompt facilitating alteration of the electronic financial transaction to include an amount of the supplemental cash transaction. The method includes receiving, by the user interface of the electronic device, user input defining the amount of the supplemental cash transaction. In response to the user input defining the amount of the supplemental cash transaction, the method comprises replacing, by the one or more processors, an electronic financial transaction amount in a register of the digital wallet application with a modified electronic financial transaction amount comprising the amount of the supplemental cash transaction.

The one or more contextual signals can include various data points that provide insight into the nature and circumstances of the transaction. For example, location data obtained from the GPS module of the electronic device can indicate whether the transaction occurred at a specific type of establishment, such as a restaurant, coffee shop, or hotel, where supplemental cash spends like tips are common. Calendar events can be cross-referenced with the transaction to determine if the payment coincides with a scheduled event, such as a hotel check-out or a food delivery appointment. Notifications received by the electronic device can also serve as contextual cues. For instance, a notification from a food delivery application indicating the completion of a delivery can prompt the system to alert the user to record any cash tip given to the delivery agent. Similarly, notifications from ride-sharing applications can signal the end of a ride, prompting the user to add any cash tip provided to the driver. Additionally, transaction metadata such as the merchant's name, transaction amount, and time of the transaction can be analyzed to identify patterns that suggest the likelihood of a supplemental cash spend.

Historical transaction data stored in the digital wallet application can further enhance the identification of contextual cues. By analyzing past transactions in a transaction database, the system can learn and predict scenarios where supplemental cash spends are likely. For example, if a user frequently tips at certain restaurants, the system can use this historical data to prompt the user to record a cash tip whenever a transaction is made at those establishments. This predictive capability ensures that supplemental cash transactions are consistently captured, providing a more accurate financial picture.

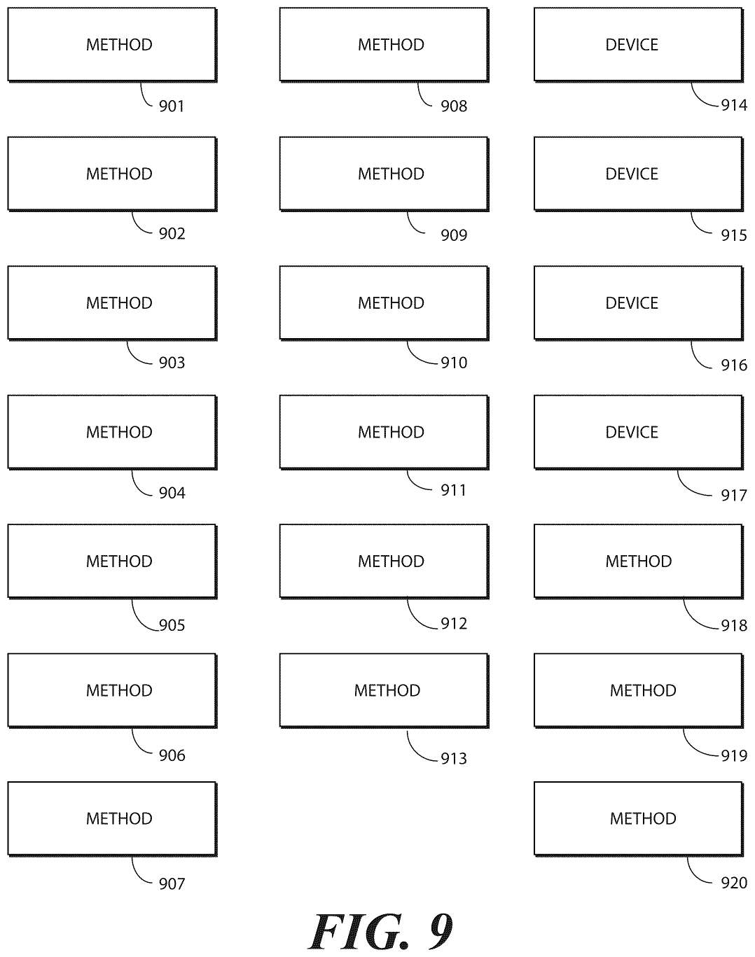

Turning now to FIG. 9 illustrated therein are various embodiments of the disclosure. The embodiments of FIG. 9 are shown as labeled boxes in FIG. 9 due to the fact that the individual components of these embodiments have been illustrated in detail in FIGS. 1-8, which precede FIG. 9. Accordingly, since these items have previously been illustrated and described, their repeated illustration is no longer essential for a proper understanding of these embodiments. Thus, the embodiments are shown as labeled boxes.

At 901, a method in an electronic device comprises detecting, with one or more processors of the electronic device, a financial transaction using a digital wallet application operable on the one or more processors of the electronic device. At 901, the method comprises extracting, by the one or more processors, one or more contextual cues from the financial transaction.

At 901, the method comprises determining, by the one or more processors, whether one or more supplemental cash payment triggers are identified by the one or more contextual cues extracted from the financial transaction. At 901, in response to determining that one or more supplemental cash payment triggers are identified by the one or more contextual cues, the method comprises presenting, by the one or more processors on a user interface of the electronic device, a prompt facilitating alteration of the financial transaction to include a supplemental cash payment.

At 902, the prompt of 901 is presented, by the one or more processors on the user interface of the electronic device, concurrently with details of the financial transaction. At 903, the prompt of 901 comprises a user actuation target. At 903, the method of 901 further comprises, in response to the user interface receiving user input actuating the user actuation target, presenting a supplemental cash payment user interaction interface allowing the supplemental cash payment to be added to the financial transaction.

At 904, the presentation of the prompt of 901 facilitating alteration of the financial transaction to include the supplemental cash payment is delayed until a subsequent electronic wallet application interaction occurs. At 905, the subsequent electronic wallet application interaction of 904 comprises the user interface receiving reconciliation user input at the electronic wallet application. At 906, the subsequent electronic wallet application interaction of 904 comprises a communication device of the electronic device receiving an event completion electronic communication.

At 907, the method of 901 further comprises storing, in a transaction database stored in a memory of the electronic device, the supplemental cash payment in a buffer of supplemental cash payments made since the user interface has received reconciliation user input at the digital wallet application. At 908, the method of 907 further comprises subtracting, by the one or more processors, the buffer of supplemental cash payments to another buffer identifying cash withdrawal transactions to obtain a cash on hand balance. At 908, the method comprises presenting, by the one or more processors, the cash on hand balance at the user interface of the electronic device.

At 909, the method of 901 further comprises querying, from a memory of the electronic device by the one or more processors, past financial transactions from the digital wallet application made by an authorized user of the electronic device that are stored in the memory. At 909, the method comprises determining, by the one or more processors, a repeating pattern of one or more repeating financial transactions comprising supplemental cash payments. At 909, the one or more processors determine at least one supplemental cash payment trigger is identified by the one or more contextual cues extracted from the financial transaction when a merchant identified by the one or more repeating financial transactions is identified by the one or more contextual cues.

At 910, the one or more supplemental cash payment triggers of 901 comprise the financial transaction being made with a food vendor. At 911, the one or more supplemental cash payment triggers of 901 comprise the financial transaction being made to complete a delivery.

At 912, the one or more supplemental cash payment triggers of 901 comprise a calendaring event stored in a calendaring application operating on the one or more processors that identifies a merchant. At 913, the one or more supplemental cash payment triggers of 901 comprise the electronic device being collocated with a merchant.

At 914, an electronic device comprises a user interface, a communication device, and one or more processors operable with the user interface and communication device and operating a digital wallet application. At 914, the one or more processors are configured to determine a probable supplemental cash payment transaction occurring concurrently with a financial transaction executed by the digital wallet application and, in response, to present a prompt allowing user input received by the user interface to manipulate the financial transaction executed by the digital wallet application.

At 915, the one or more processors of 914, in response to the user input, alter the financial transaction by an amount defined by the user input. At 916, the one or more processors of 915, in response to the digital wallet application being transitioned to a reconciliation mode of operation, present the amount as a visible adjustment to the financial transaction. At 917, the one or more processors of 916, in response to other user input being received by the user interface that interacts with a user selected financial transaction presented in the reconciliation mode of operation, present another prompt allowing subsequent user input received by the user interface to manipulate the user selected financial transaction presented in the reconciliation mode of operation.

At 918, a method in an electronic device comprises identifying, by one or more processors of the electronic device, one or more contextual signals indicative of an electronic financial transaction occurring in a digital wallet application operating on the one or more processors occurring concurrently with a supplemental cash transaction associated with the electronic financial transaction. At 918, the method comprises presenting, by the one or more processors on a user interface of the electronic device, a prompt facilitating alteration of the electronic financial transaction to include an amount of the supplemental cash transaction.

At 918, the method comprises receiving, by the user interface of the electronic device, user input defining the amount of the supplemental cash transaction. At 918, in response to the user input, the method comprises replacing, by the one or more processors, an electronic financial transaction amount in a register of the digital wallet application with a modified electronic financial transaction amount comprising the amount of the supplemental cash transaction.

At 919, the one or more contextual signals of 918 comprise a communication device receiving an electronic communication from a merchant payment processor system. At 920, presentation of the prompt of 918 facilitating alteration of the electronic financial transaction is delayed until a predefined event occurs subsequent to the electronic financial transaction.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

1. A method in an electronic device, the method comprising:
detecting, with one or more processors of the electronic device, a financial transaction using a digital wallet application operable on the one or more processors of the electronic device;
extracting, by the one or more processors, one or more contextual cues from the financial transaction;
determining, by the one or more processors, whether one or more supplemental cash payment triggers are identified by the one or more contextual cues extracted from the financial transaction; and
in response to determining that one or more supplemental cash payment triggers are identified by the one or more contextual cues, presenting, by the one or more processors on a user interface of the electronic device, a prompt facilitating alteration of the financial transaction to include a supplemental cash payment.

2. The method of claim 1, wherein the prompt is presented, by the one or more processors on the user interface of the electronic device, concurrently with details of the financial transaction.

3. The method of claim 1, wherein the prompt comprises a user actuation target, further comprising, in response to the user interface receiving user input actuating the user actuation target, presenting a supplemental cash payment user interaction interface allowing the supplemental cash payment to be added to the financial transaction.

4. The method of claim 1, wherein presentation of the prompt facilitating alteration of the financial transaction to include the supplemental cash payment is delayed until a subsequent electronic wallet application interaction occurs.

5. The method of claim 4, wherein the subsequent electronic wallet application interaction comprises the user interface receiving reconciliation user input at the digital wallet application.

6. The method of claim 4, wherein the subsequent electronic wallet application interaction comprises a communication device of the electronic device receiving an event completion electronic communication.

7. The method of claim 1, further comprising storing, in a transaction database stored in a memory of the electronic device, the supplemental cash payment in a buffer of supplemental cash payments made since the user interface has received reconciliation user input at the digital wallet application.

8. The method of claim 7, further comprising subtracting, by the one or more processors, the buffer of supplemental cash payments to another buffer identifying cash withdrawal transactions to obtain a cash on hand balance, and presenting, by the one or more processors, the cash on hand balance at the user interface of the electronic device.

9. The method of claim 1, further comprising:
querying, from a memory of the electronic device by the one or more processors, past financial transactions from the digital wallet application made by an authorized user of the electronic device that are stored in the memory; and
determining, by the one or more processors, a repeating pattern of one or more repeating financial transactions comprising supplemental cash payments;
wherein the one or more processors determine at least one supplemental cash payment trigger is identified by the one or more contextual cues extracted from the financial transaction when a merchant identified by the one or more repeating financial transactions is identified by the one or more contextual cues.

10. The method of claim 1, wherein the one or more supplemental cash payment triggers comprise the financial transaction being made with a food vendor.

11. The method of claim 1, wherein the one or more supplemental cash payment triggers comprise the financial transaction being made to complete a delivery.

12. The method of claim 1, wherein the one or more supplemental cash payment triggers comprise a calendaring event stored in a calendaring application operating on the one or more processors that identifies a merchant.

13. The method of claim 1, wherein the one or more supplemental cash payment triggers comprise the electronic device being collocated with a merchant.

14. An electronic device, comprising:
a user interface;
a communication device; and
one or more processors operable with the user interface and communication device and operating a digital wallet application;
wherein the one or more processors are configured to determine from contextual cues a probable supplemental cash payment transaction occurring concurrently with a financial transaction executed by the digital wallet application and, in response, to present a prompt.

15. The electronic device of claim 14, wherein:
the prompt allows user input received by the user interface to manipulate the financial transaction executed by the digital wallet application; and
the one or more processors, in response to the user input, alter the financial transaction by an amount defined by the user input.

16. The electronic device of claim 15, wherein the one or more processors, in response to the digital wallet application being transitioned to a reconciliation mode of operation, present the amount as a visible adjustment to the financial transaction.

17. The electronic device of claim 16, wherein the one or more processors, in response to other user input being received by the user interface that interacts with a user selected financial transaction presented in the reconciliation mode of operation, present another prompt allowing subsequent user input received by the user interface to manipulate the user selected financial transaction presented in the reconciliation mode of operation.

18. The method of claim 1, further comprising:
detecting the financial transaction occurring in the digital wallet application operating on the one or more processors occurring concurrently with a supplemental cash transaction associated with the financial transaction;
wherein the prompt facilitating alteration of the financial transaction includes an amount of the supplemental cash transaction;
receiving, by the user interface of the electronic device, user input defining the amount of the supplemental cash transaction; and
in response to the user input, replacing, by the one or more processors, an electronic financial transaction amount in a register of the digital wallet application with a modified electronic financial transaction amount comprising the amount of the supplemental cash transaction.

19. The method of claim 18, wherein the one or more contextual cues comprise an electronic communication from a merchant payment processor system.

20. The method of claim 18, wherein presentation of the prompt facilitating alteration of the financial transaction is delayed until a predefined event occurs subsequent to the financial transaction.
